(19) United States
(12) Patent Application Publication
(10) Pub. No.: US 2021/0400860 A1
(43) Pub. Date: Dec. 30, 2021

(54) A KIT FOR A SOIL TREATING TOOL

(71) Applicant: JOHN DUFFIN, BELFAST (GB)

(72) Inventor: JOHN DUFFIN, BELFAST (GB)

(21) Appl. No.: 17/288,711

(22) PCT Filed: Oct. 24, 2019
(86) PCT No.: PCT/EP2019/079100

§ 371 Date: Apr. 26, 2021

(30) Foreign Application Priority Data
Oct. 24, 2018 (GB) 1817319.5

(51) Int. Cl. A01B 29/04; A01B 29/06; A01B 45/02

(52) U.S. Cl. CPC A01B 29/045; A01B 45/02; A01B 29/06

(57) ABSTRACT

A kit for converting a roller into an aerator tool comprising at least one cover layer intended to be removably applied and fix around the roller, the external surface of said cover layer being provided with means for penetrating into the soil.

The present invention relates to a kit for a soil treating tool and in particular to a kit for converting a roller into an aerator tool.

In the agricultural field roller tools are widely known and used. In particular, they are generally used for flattening land or breaking up large clumps of soil, especially after ploughing. Indeed, flatter land makes subsequent weed control and harvesting easier, and rolling can help to reduce moisture loss from cultivated soil. Typically, rollers are pulled by tractors and moreover they can be used on lawns for leveling the land before the mowing and for compacting the soil surface. More in detail, the rollers usually consist of one or more cylinders that may be weighted in different ways. Indeed, there are rollers with cylinders made of thick steel, a thinner steel cylinder filled with concrete, or a cylinder filled with water. A water-filled roller has the advantage that the water may be drained out for lighter use or for transport.

In the same field, aerator tools are also widely known and used. In particular, they are tools designed to create holes in the soil to allow air and moisture and nutrients to enter the soil. The holes also serve as receptacles for seed to prevent the seed from being washed away and to promote germination and growth. More in detail, aerating the soil with such tool allows oxygen, water and nutrients to get directly to the root system, improves root structure and allows fresh roots to grow deeper, improves yields and reduces fertilizer costs, improves drainage and slurry absorption resulting in less damage to land, allows extended grazing and cutting periods, extends the life of permanent pasture without the need for expensive reseeding. Numerous aeration devices have been available and they usually comprise a large cylindrical drum mounted about its periphery with a plurality of radially extending elements. The drum is pulled over the ground and, as it rolls, the protruding elements are driven into the soil to create holes.

It is understood that the farmers must use both compacting roller and aerator tools in order to treat the soil. Known rollers are configured only to be used for soil flattening and, in the same way, known aerators are configured for creating holes in the soil, so the farmers must necessarily buy two corresponding independent tools.

In this context, especially considering that the farmers are generally very careful in spending their money for buying new tools and tend to avoid substituting old tools until they no longer work, there is a need to save money for avoiding the purchase of two separate tools, one working as a roller and one working as an aerator.

It is an object of the present invention to prevent or mitigate cost problems of buying two separate tools for soil rolling and aerating, thus providing a way to use as and when required a single tool both as a roller and as an aerator.

Another object of the invention is to provide a kit for converting a roller into an aerator tool easily and quickly.

Another object of the invention is to provide a kit for converting a standard and conventional roller into an aerator tool.

Another object of the invention is to provide a kit for converting a roller into an aerator tool offering greater soil penetration.

Another object of the invention is to provide a kit for converting a roller into an aerator tool that allows both to create holes in the top layer of grassland and to shatter the hard pan.

Another object of the invention is to provide a kit for converting a roller into an aerator tool that has an alternative and improved characterisation and design, in both constructional and functional terms, compared with the known ones.

Another object of the invention is to provide a kit for converting a roller into an aerator tool of easy, quick and low-cost construction.

Accordingly, all these objects, taken individually and in any combination thereof, are achieved according to the invention by a kit for converting a roller into an aerator tool comprising at least one cover layer intended to be removably applied around the roller, the external surface of said cover layer being provided with means for penetrating into the soil.

Advantageously, the means for penetrating into the soil comprise means for creating/punching holes in the soil.

Advantageously, the means for penetrating into the soil comprise means for pulling out plugs from soil.

Preferably, the means for penetrating into the soil comprise a plurality of protruding elements.

Ideally, the means for penetrating into the soil comprise a plurality of spikes, tines and/or blades and/or varying combinations thereof.

Advantageously, the means for penetrating into the soil comprise a plurality of elements that extend outward radially, tangentially, or in a manner therebetween, from the external surface of the cover layer and are spaced along the longitudinal development of said cover layer.

Advantageously, the means for penetrating into the soil comprise a plurality of planar pieces. Preferably, the planar pieces have polygonal shape. Ideally, the planar pieces have trapezoidal shape.

Advantageously, the planar pieces have at least one straight external edge. Preferably, said planar pieces have a sharp external edge.

Advantageously, the planar pieces have an internal edge that is attached to the external surface of the cover layer.

Advantageously, the planar pieces have two lateral edges with different extensions.

Ideally, the planar pieces have an external edge that is narrower than the internal one.

Advantageously, the planar pieces have an external edge that is angled in respect of the internal edge that is attached to external surface of said cover.

Preferably, the external edges of all planar pieces of each cover are inclined along the circumferential development in the same direction.

Advantageously, the internal edge of the planar pieces that is attached to the external surface of the cover layer has the same degree/radius of curvature of the external surface of the cover layer.

Preferably, the internal edge of the planar pieces that is attached to the external surface of the cover layer has the same degree/radius of curvature of the roller around which the cover layer is intended to be applied.

Advantageously, the means for penetrating into the soil are permanently fixed to the external surface of said cover layer. Preferably, the means for penetrating into the soil are welded to the external surface of said cover layer.

Advantageously, the means for penetrating into the soil are removable associated to the external surface of said cover layer. Preferably, the means for penetrating into the soil are screwed into corresponding seats defined on the external surface of said cover layer.

Advantageously, the means for penetrating into the soil comprise a plurality of protruding elements that are staggered according to a regular pattern.

Advantageously, the means for penetrating into the soil comprise a plurality of protruding elements that are disposed in staggered rows.

Advantageously, at least two means for penetrating into the soil are placed on the same ideal plane crossing the surface of the cover layer. Preferably, the means for penetrating into the soil are groups in rows that are arranged so as to lie in the same cross plane of the cover layer and so as to be spaced along the circumferential development of the cover itself.

Preferably, the rows of the means for penetrating into the soil are staggered along the longitudinal development of the cover layer, that is along the length of the rotating axis. Ideally, the staggered rows of the means for penetrating into the soil are arranged so as to cover the whole circumferential development of the cover layer. Ideally, the means for penetrating into the soil belonging to different rows are partially overlapped along the longitudinal direction.

Preferably, the means for penetrating into the soil are arranged on the surface of the cover layer so that at least two protruding elements are faced along the longitudinal direction of the cover layer.

Preferably, the means for penetrating into the soil are arranged on the surface of the cover layer so as to be staggered in a circumferential direction.

Advantageously, the internal surface of the cover layer being configured to be at least in part, preferably entirely, in contact with the cylindrical surface of the roller on which the cover layer is intended to be applied.

Advantageously, the degree/radius of curvature of the cover layer corresponds substantially to the one of the roller on which it is intended to be applied.

Ideally, the cover layer is rigid. By rigid we mean that the cover layer is made from a stiff material which is not readily flexible, pliable or bendable.

Advantageously, the cover layer is a liner that is intended to be fitted onto the roller.

Preferably, the cover layer is a metal sheet. Ideally, the cover layer is made of steel.

Advantageously, the cover layer comprises at least two sections of a cylinder surface.

Preferably, each cover layer is half section of a cylinder surface.

Preferably, each cover layer has a semi cylindrical shape. Ideally, each cover layer is a semi cylindrical metal sheet.

Advantageously, the kit comprises at least two cover layers having the same shape and/or size. Preferably, the kit comprises at least two cover layers that are complementary and symmetric.

Advantageously, the kit comprises at least two cover layers reciprocally fastened at their longitudinal edges by means of coupling means, most preferably detachable coupling means. By detachable coupling means we mean not permanent coupling means which are readily removable coupling means by unscrewing or unbolting.

Advantageously, each cover layer comprises a flange portion along its longitudinal sides. Preferably, each flange portion extends radially outward from the two longitudinal edges of each cover layer.

Preferably, the flange portion is defined by at least a portion of the cover layer that is folded along its longitudinal side.

Advantageously, the coupling means comprise two corresponding facing flange portions, one for each of the two adjacent cover layers. Ideally, each flange portion of the cover layer is configured, shaped and sized so as to be faced with a corresponding flange portion of an adjacent cover layer.

Advantageously, the coupling means comprise mechanical fasteners for securing together two adjacent cover layers. Preferably, the mechanical fasteners comprise joining elements for inserting into corresponding holes defined on the cover layers. Preferably, the holes are defined on the flange portion of the cover layer.

Advantageously, each cover layer comprises a lip portion at one longitudinal side and a recess at the opposite longitudinal side for receiving the lip portion of an adjacent cover layer.

Advantageously, the kit comprises at least two cover layers that are aligned and flanked along their longitudinal development.

Advantageously, each cover layer has a longitudinal extension that corresponds to the one of each roller component around which the cover is intended to be applied.

Advantageously, the kit comprises means for facilitating the positioning and/or installation of the cover layer around the roller.

Advantageously, the means for facilitating the positioning comprise female members defined on said cover layer and intended to receive corresponding male members of the roller, or vice versa.

Preferably, the means for facilitating the positioning comprise holes defined on said cover layer and intended to receive corresponding pins extending radially outward from the cylindrical surface of the roller, or vice versa. Preferably, means for facilitating the positioning comprise at least two sets of pins that are reciprocally spaced along the longitudinal and/or circumferential development of the roller.

Advantageously, the kit comprises means for locking the position and the movement of the cover layer around the roller along at least two directions. Advantageously, the locking means prevents the cover layer from rotating around the axis of rotation of the roller.

Advantageously, the locking means prevents the cover layer and the soil penetrating means from moving laterally along the length of the roller.

Preferably, the locking means work also as means for facilitating the positioning of the cover layer around the roller.

Advantageously, the locking means comprise female members defined on the cover layer and intended to receive corresponding male members of the roller, or vice versa.

Preferably, the locking means comprise holes defined on said cover layer and intended to receive corresponding pins extending radially outward from the cylindrical surface of the roller, or vice versa. Preferably, the locking means comprise at least two sets of pins that are reciprocally spaced along the longitudinal and/or circumferential development of the roller.

Preferably, said locking means are configured so as to define the longitudinal position of each cover along the roller.

Ideally, the kit is adapted for use with a single axis of rotation roller having one or more rollers all of which are mounted on a single axis of rotation.

Ideally, the kit is adapted for use with an apparatus with at least one roller, wherein the at least one roller or all of the rollers of the apparatus roll at ground speed only.

Preferably, the kit being adapted for use with an apparatus with at least one roller, wherein the at least one roller or all of the rollers of the apparatus have the same roller diameter.

According to a further aspect of the invention, there is provided an improved equipment for soil treating comprising a traditional roller for soil compacting and a kit with one or more of the features above.

Advantageously, the roller is a drum provided with a cylindrical surface and a pair of end walls. Preferably, the drum is smoothing and/or idler cylinder and/or is water-filled.

Preferably, the drum is formed of any sturdy metal, preferably steel.

Preferably, the roller comprises means for facilitating the application of the cover layer around the roller itself.

Preferably, the roller is provided with means for attaching to a drawbar of a tractor.

Ideally, the roller is mounted on arms of a frame intended to be attached to a drawbar of a tractor. Ideally, the roller is mounted on a support yoke intended to be attached to a drawbar of a tractor.

Ideally, the roller is a single standalone roller operating as a roller or an aerator. Advantageously, use of the kit with a single standalone roller means the conversion is a simple process and there are no further components, connections, or other connected parts to get in the way of the kit during conversion.

In another embodiment, the roller comprises more than one roller all rotating about the same axis of rotation.

According to a further aspect of the invention, there is provided a method for converting at need a roller into an aerator tool, or vice versa, by applying and mounting, or by removing, a kit with one or more of the features above.

The skilled man will appreciate that all preferred or optional features of the invention described with reference to only some aspects or embodiments of the invention may be applied to all aspects of the invention.

It will be appreciated that optional features applicable to one aspect of the invention can be used in any combination, and in any number. Moreover, they can also be used with any of the other aspects of the invention in any combination and in any number. This includes, but is not limited to, the dependent claims from any claim being used as dependent claims for any other claim in the claims of this application.

The invention will now be described with reference to the accompanying drawings which show by way of example only one embodiment of a screen box in accordance with the invention.

In the drawings:

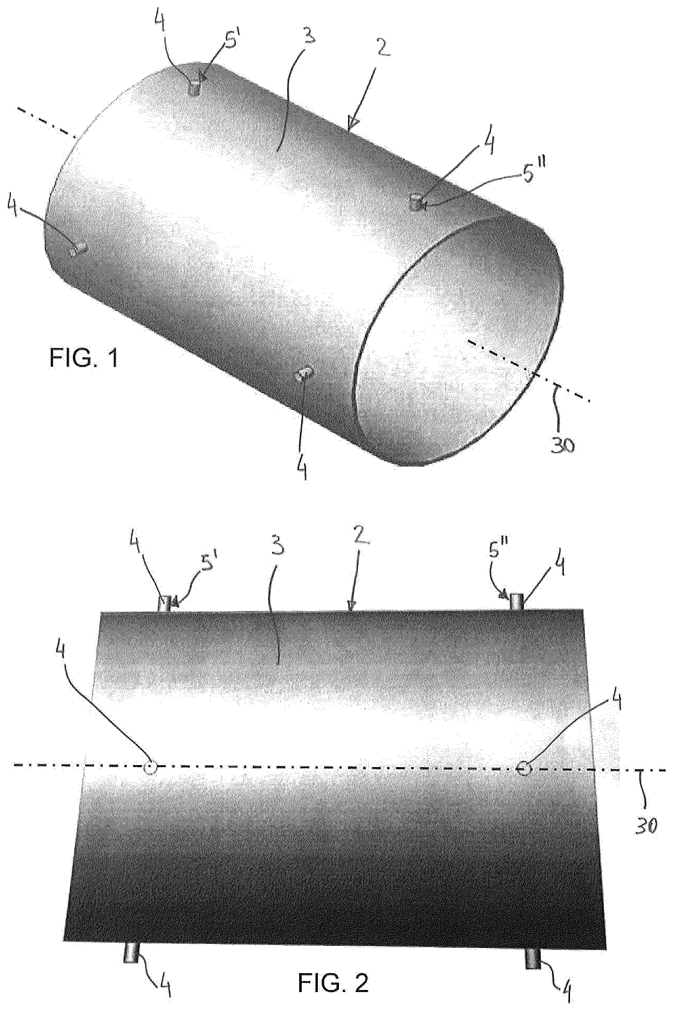

FIG. 1 is a perspective view of a roller;

FIG. 2 is a lateral view of the roller

FIG. 3 is a perspective view of one component of the kit according to the invention,

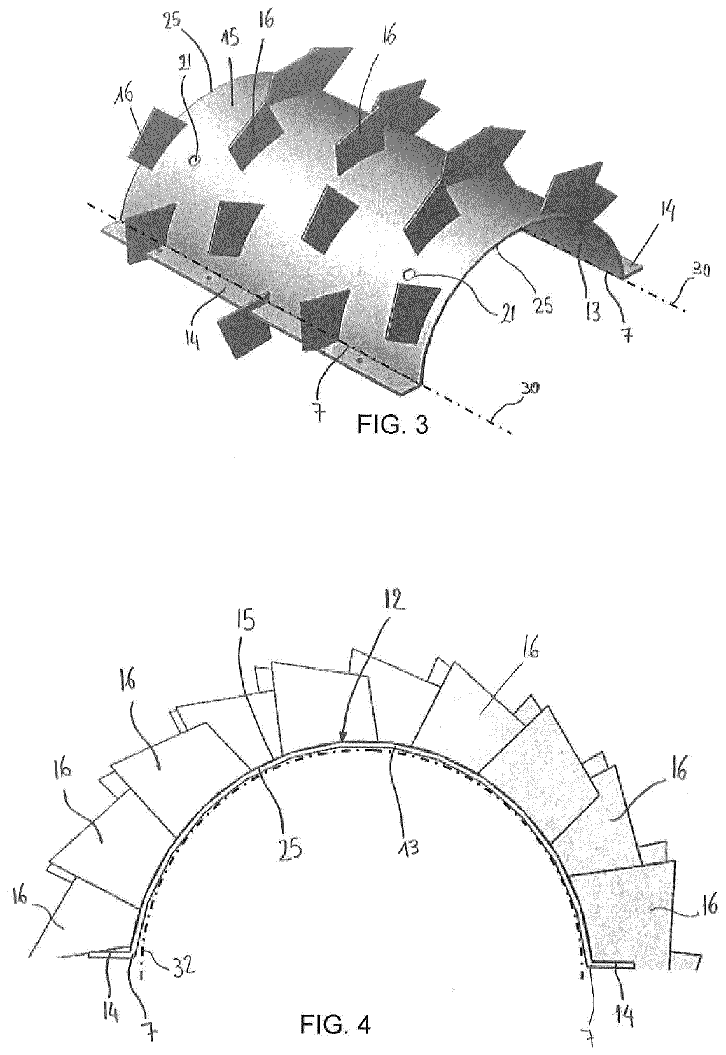

FIG. 4 is a frontal view of the component of FIG. 3,

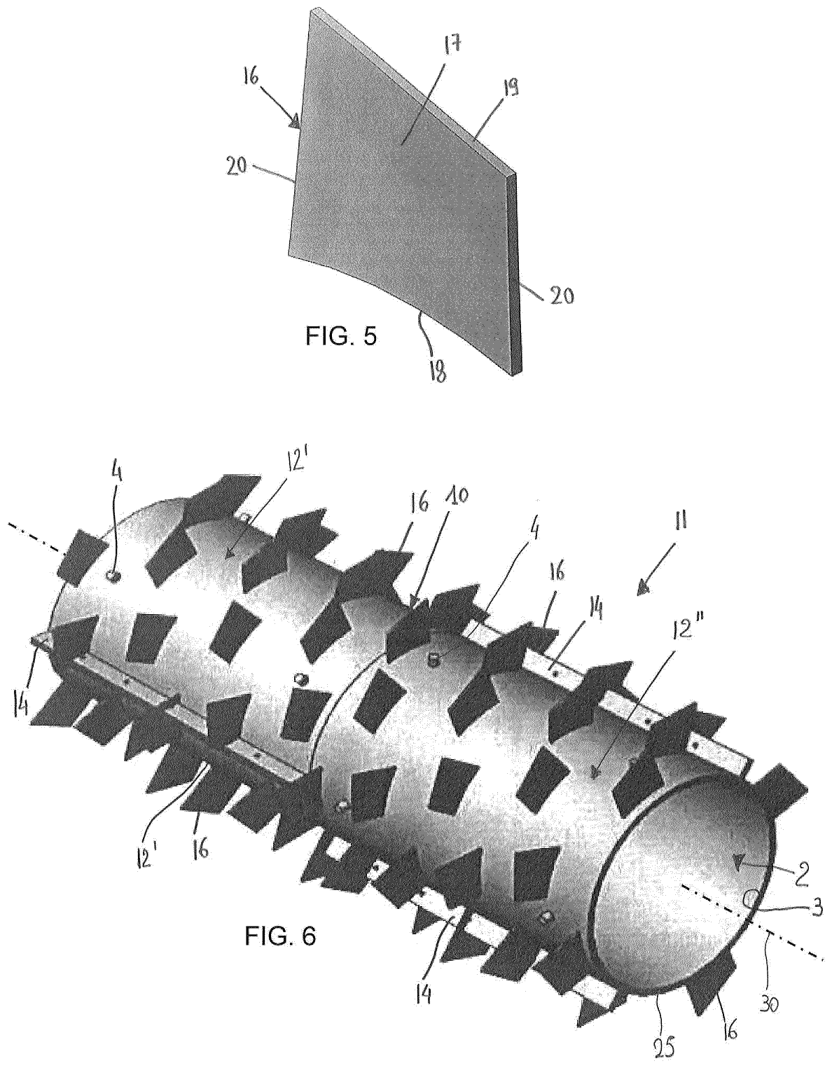

FIG. 5 is a perspective view of a particular of the component of FIG. 3,

FIG. 6 is a perspective view of the kit according to the invention applied to the roller, and

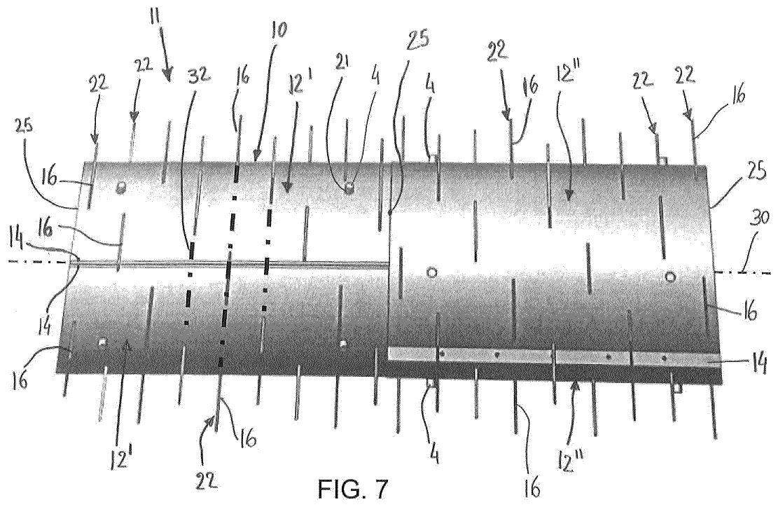

FIG. 7 is a lateral view of the kit of FIG. 6.

Referring to the FIGS. 1 and 2, there is shown a standard roller 2 that consists of a drum provided with a cylindrical surface 3 that is generally closed with a pair of end walls on which are mounted the arms (not shown) of a frame for attaching to the drawbar of a tractor.

Preferably, the roller 2 is made of sturdy metal, preferably steel.

Referring to the figures from 3 to 7, there is shown a kit 10 according to the invention for converting the roller 2 into an aerator tool 11. In particular, the kit 10 comprises two cover layers 12 intended to be removably applied and fix around the external cylindrical surface 3 of the roller 2. More in detail, each cover layer 12 is made of a steel sheet having a semi cylindrical shape.

Advantageously, the degree of curvature of the internal surface 13 of each cover layer 12 corresponds to the one of the cylindrical surface 3 of the roller 2 in order to allow a proper continuous contact between such surfaces.

Each cover layer 12 presents a flange portion 14 along its longitudinal edge 7. Advantageously, the flange portion 14 is obtained by folding the sheet defining the cover layer along its longitudinal edges 7. Preferably, the flange portion 14 extends radially outward from the two longitudinal edges 7 of the semi cylindrical surface constituting each cover layer 12.

Each flange portion 14 of the semi cylindrical cover layer 12 is configured, shaped and sized so as to be faced with a corresponding flange portion 14 of the other complementary semi cylindrical cover layer 12. Advantageously, the facing flange portions 14 of two complementary cover layers 12 are coupled together by means of suitable mechanical fasteners. More in detail, each flange portion 14 presents holes that, when aligned, are intended to be crossed by joining elements, such as for example a rivet, a dowel, a bolt clamped with a nut, or even a screw if the holes are internally threaded.

Each cover layer 12 is provided at its external surface 15 with a plurality of protruding elements 16 defining the means for penetrating into the soil in order to create holes in it. In particular, in the embodiments shown in the figures, the protruding elements 16 are blades that extend radially outward from the external surface 15 so that the soil penetrating means are continually entering and leaving the soil as the cover layers 12 wrapping the roller travel along the ground.

As shown more in detail in FIG. 5, each blade 16 consists of a planar piece 17 having substantially a trapezoidal shape. More in detail, the internal edge 18 is suitably curved so as to be attached to the external surface 15 of the cover layer 12 while the external edge 19 is inclined since the two lateral edges 20 have different extensions. Preferably, the blades 16 are welded to the external surface 15 of the cover layer 12.

Advantageously, two or more blades 16 are groups in rows 22 that are arranged so as to lie in the same cross plane of the cover layer 12 and so as to be spaced along the circumferential development 32 of the cover itself. The rows 22 of the blades are staggered along the longitudinal development 30 of the cover layer 12, that is along the length of the rotating axis. The staggered rows 22 of the blades are arranged so as to cover the whole circumferential development 32 of the cover layer 12 and, preferably, the blades 16 of different rows are partially overlapped along the longitudinal development 30.

Preferably, as clearly shown in FIG. 4, the external edges 19 of blades 16 are all inclined circumferentially in the same direction.

Advantageously, the cylindrical surface 3 of the roller 2 is provided with pins 4 that extend radially outward. These pins 4 are advantageous since they work both as reference element for the correct installation of the cover layer 12 of the kit 10 on the roller 2 and also as means for locking the position of the cover layer 12 both along a circumferential direction and a longitudinal direction of the roller itself. Preferably, there are two sets 5′ and 5″ of pins 4 that are reciprocally spaced along the longitudinal development of the roller 2, while the pins 4 of each set 5′, 5″ are spaced along the circumferential development.

Advantageously, each cover layer 12 is provided with holes 21 wherein are intended to be inserted the corresponding pins 4 of the roller 2.

As shown in FIGS. 6 and 7, two pairs of complementary semi cylindrical cover layers 12′ and 12″ are applied around the corresponding sections of the roller 2 so that they are aligned and flanked along the longitudinal development 30 of the same roller or cover layer. It means that the cross edge 25 of each cover layer 12′ is substantially in contact or in proximity of the cross edge of the cover layer 12″ that is longitudinally aligned.

The operating way of the kit 10 according to the invention results clearly from the above description. In particular, in order to convert a roller 2 into an aerator tool 11, the user applies each cover layer 12 around the cylindrical surface 3 of the roller 2. In particular, the application and the positioning of the cover layer 12 is facilitated by inserting the holes 21 into the pins 4 protruding from the cylindrical surface 3 of the roller 2. Once this is done, the cover layer 12 results locked onto the roller 2 along the longitudinal and circumferential directions.

When the two-complementary semi cylindrical cover layers 12 are applied around the roller 2 so that the corresponding flange portions 14 are facing and in contact, these two layers 12 are joined together around the roller 2 by using suitable fastening means at said flange portions. Therefore, when the kit is applied on the roller 2, the latter is converted into the aerator tool 11.

The rotation, that is generally powered from the tractor, of the roller 2 with the kit applied, allows to the penetrating members 16 to enter and pierce the soil for creating aerating holes.

In a corresponding way, if the user does not need the aerator anymore and needs instead the roller alone, he just quickly and easily removes the cover layers 12 from the roller 2 so that the smooth cylindrical surface 3 can be used, for example for flattening and/or compacting the soil.

From the above disclosure, the advantages of the kit 10 according to this invention are apparent, since it allows to convert easily and quickly a standard roller into an aerator tool. Moreover, such kit is extremely easy and cheap to construct since it is made of a single metal sheet that is suitably curved, punched and/or folded, and that is provided with a plurality of welded protruding members defining the means for ground soil penetration.

In relation to the detailed description of the different embodiments of the invention, it will be understood that one or more technical features of one embodiment can be used in combination with one or more technical features of any other embodiment where the transferred use of the one or more technical features would be immediately apparent to a person of ordinary skill in the art to carry out a similar function in a similar way on the other embodiment.

In the preceding discussion of the invention, unless stated to the contrary, the disclosure of alternative values for the upper or lower limit of the permitted range of a parameter, coupled with an indication that one of the said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The features disclosed in the foregoing description or the following drawings, expressed in their specific forms or in terms of a means for performing a disclosed function, or a method or a process of attaining the disclosed result, as appropriate, may separately, or in any combination of such features be utilised for realising the invention in diverse forms thereof as defined in the appended claims.

1. A kit (10) for converting a roller (2) into an aerator tool (11) comprising at least one rigid cover layer (12, 12′, 12″) intended to be removably applied and fixed around the roller (2), the external surface (15) of said rigid cover layer (12, 12′, 12″) being provided with means (16) for penetrating into the soil.

2. A kit (10) as claimed in claim 1, wherein an internal surface (12) of the cover layer (12, 12′, 12″) being configured to be at least in part, preferably entirely, in contact with a cylindrical surface (3) of the roller (2) around which the cover layer (12, 12′, 12″) is intended to be applied.

3. A kit (10) as claimed in any of the preceding claims, wherein the degree of curvature of the cover layer (12, 12′, 12″) corresponds substantially to the degree of curvature of the roller (2) on which said cover layer (12, 12′, 12″) is intended to be applied.

4. A kit (10) as claimed in any of the preceding claims, wherein the cover layer (12, 12′, 12″) is a liner that is intended to be fitted onto the roller (2).

5. A kit (10) as claimed in any of the preceding claims, wherein the cover layer (12, 12′, 12″) is made from a steel sheet.

6. A kit (10) as claimed in any of the preceding claims, wherein the cover layer (12, 12′, 12″) comprises at least two sections of a cylinder surface.

7. A kit (10) as claimed in the preceding claim, wherein each cover layer (12, 12′, 12″) has a semi cylindrical shape, preferably made of a semi cylindrical metal sheet.

8. A kit (10) as claimed in any of the preceding claims, wherein the kit (10) comprises at least two cover layers (12, 12′, 12″) having the same shape and/or size.

9. A kit (10) as claimed in any of the preceding claims, wherein the kit (10) comprises at least two cover layers (12, 12′, 12″) that are complementary and symmetric.

10. A kit (10) as claimed in any of the preceding claims, wherein the kit (10) comprises at least two cover layers (12, 12′, 12″) reciprocally fastened at their longitudinal edges by means of detachable coupling means.

11. A kit (10) as claimed in any of the preceding claims, wherein each cover layer (12, 12′, 12″) comprises a flange portion (14) along its longitudinal sides.

12. A kit (10) as claimed in claim 11, wherein each flange portion (14) extends radially outward from the two longitudinal edges (7) of each cover layer (12, 12′, 12″).

13. A kit (10) as claimed in claim 11 or 12, wherein the flange portion (14) is defined by at least a portion of the cover layer (12, 12′, 12″) that is folded along its longitudinal edge (7).

14. A kit (10) as claimed in any of the claims 11-13, wherein each flange portion (14) of the cover layer (12, 12′, 12″) is configured, shaped and sized so as to be faced with a corresponding flange portion (14) of an adjacent cover layer (12, 12′, 12″).

15. A kit (10) as claimed in claims 10-14, wherein the detachable coupling means comprise two corresponding facing flange portions (14), one for each of the two adjacent cover layers (12, 12′, 12″).

16. A kit (10) as claimed in any of the claims 10-15, wherein the detachable coupling means comprise releasable mechanical fasteners for securing together two adjacent cover layers (12, 12′, 12″).

17. A kit (10) as claimed in claim 16, wherein the mechanical fasteners comprise joining elements for inserting into corresponding holes defined on the cover layers (12, 12′, 12″).

18. A kit (10) as claimed in claim 17 when dependent on any one of claims 11 to 17, wherein the holes are defined on the flange portion (14) of the cover layers (12, 12′, 12″).

19. A kit (10) as claimed in any of the preceding claims, wherein each cover layer (12, 12′, 12″) comprises a lip portion at one longitudinal edge (7) and a recess at the opposite longitudinal side for receiving the lip portion of an adjacent cover layer (12, 12′, 12″).

20. A kit (10) as claimed in claim 19, wherein each cover layer (12, 12′, 12″) comprises a lip portion at one cross edge (23) and a recess at the opposite cross edge for receiving the lip portion of an adjacent cover layer (12, 12′, 12″).

21. A kit (10) as claimed in any of the preceding claims, wherein the kit (10) comprises at least two cover layers (12, 12′, 12″) that are aligned and flanked along their longitudinal development (30).

22. A kit (10) as claimed in any of the preceding claims, wherein each cover layer (12, 12′, 12″) has a longitudinal extension that corresponds to the one of each component of the roller (2) around which the cover layer is intended to be applied.

23. A kit (10) as claimed in any of the preceding claims, wherein the kit (10) comprises means (4, 21) for facilitating the positioning and/or installation of the cover layer (12, 12′, 12″) around the roller (2).

24. A kit (10) as claimed in claim 23, wherein the means for facilitating the positioning comprise female members (21) defined on said cover layer (12, 12′, 12″) and intended to receive corresponding male members (4) of the roller (2), or vice versa.

25. A kit (10) as claimed in claim 23 or claim 24, wherein the means for facilitating the positioning comprise holes (21) defined on said cover layer (12, 12′, 12″) and intended to receive corresponding pins (4) extending radially outward from the cylindrical surface (3) of the roller (2), or vice versa.

26. A kit (10) as claimed in any one of claims 23 to 25, wherein the means for facilitating the positioning comprise at least two sets of pins (4) that are reciprocally spaced along the longitudinal (30) and/or circumferential development (32) of the roller (2).

27. A kit (10) as claimed in any of the preceding claims, wherein the kit (10) comprises means (4, 21) for locking the position and the movement of the cover layer (12, 12′, 12″) around the roller (2) along at least two directions.

28. A kit (10) as claimed in the preceding claim, wherein the locking means (4, 21) also works as a means for facilitating the positioning of the cover layer (12, 12′, 12″) around the roller (2).

29. A kit (10) as claimed in claim 27 or 28, wherein the locking means comprise female members (21) defined on said cover layer (12, 12′, 12″) and intended to receive corresponding male members (4) of the roller (2), or vice versa.

30. A kit (10) as claimed in any one of claims 27 to 28, wherein the locking means comprise holes (21) defined on said cover layer (12, 12′, 12″) and intended to receive corresponding pins (4) extending radially outward from the cylindrical surface (3) of the roller (2), or vice versa.

31. A kit (10) as claimed in any of the claims 27 to 30, wherein the locking means comprise at least two sets of pins (4) that are reciprocally spaced along the longitudinal (30) and/or circumferential development (32) of the roller (2).

32. A kit (10) as claimed in any of the claims 27-31, wherein said locking means (4, 21) are configured so as to define the longitudinal position of each cover (12, 12′, 12″) on the roller (2).

33. A kit (10) as claimed in any preceding claim, wherein the means (16) for penetrating into the soil comprise means for creating/punching holes in the soil.

34. A kit (10) as claimed in any preceding claim, wherein the means (16) for penetrating into the soil comprise means for pulling out plugs from soil.

35. A kit (10) as claimed in any of the preceding claims, wherein the means (16) for penetrating into the soil comprise a plurality of protruding elements.

36. A kit (10) as claimed in claim 35, wherein the means (16) for penetrating into the soil comprise a plurality of spikes, tines and/or blades and/or varying combinations thereof.

37. A kit (10) as claimed in any of the preceding claims, wherein the means (16) for penetrating into the soil comprise a plurality of elements that extend outward radially, tangentially, or in a manner therebetween, from the external surface (15) of the cover layer (12) and are spaced along the longitudinal development (30) of said cover layer (12).

38. A kit (10) as claimed in any of the preceding claims, wherein the means (16) for penetrating into the soil comprise a plurality of planar pieces (17).

39. A kit (10) as claimed claim 38, wherein the planar pieces (17) have polygonal shape, preferably trapezoidal shape.

40. A kit (10) as claimed in claim 38 or 39, wherein the planar pieces (17) have at least one straight and/or sharp external edge (19).

41. A kit (10) as claimed in any of the claims 38-40, wherein the planar pieces (17) have an internal edge that (18) is attached to the external surface (15) of the cover layer (12).

42. A kit (10) as claimed in any of the claims 38-41, wherein the planar pieces (17) have two lateral edges (20) with different extensions.

43. A kit (10) as claimed in any of the claims 38-42, wherein the planar pieces (17) have an external edge (19) that is narrower than the internal one (18).

44. A kit (10) as claimed in any of the claims 38-43, wherein the planar pieces (17) have an external edge (19) that is angled in respect of the internal edge (18) that is attached to external surface (15) of said cover (12).

45. A kit (10) as claimed in any of the claims 38-44, wherein the external edges (19) of all planar pieces (17) of each cover (12) are inclined along the circumferential development (32) in the same direction.

46. A kit (10) as claimed in any of the claims 38-45, wherein the internal edge (18) of the planar pieces (17) has the same radius of curvature of the external surface (15) of the cover layer (12, 12′, 12″) on which is applied.

47. A kit (10) as claimed in any of the claims 38-46, wherein the internal edge (18) of the planar pieces (17) has the same radius of curvature of the roller (2) around which the cover layer (12) provided with said planar pieces (17) is intended to be applied.

48. A kit (10) as claimed in any of the preceding claims, wherein the means (16) for penetrating into the soil are permanently fixed to the external surface (15) of said cover layer (12, 12′, 12″).

49. A kit (10) as claimed in the preceding claim, wherein the means (16) for penetrating into the soil are welded to the external surface (15) of said cover layer (12, 12′, 12″).

50. A kit (10) as claimed in any of the preceding claims 1 to 47, wherein the means (16) for penetrating into the soil are removably associated to the external surface (15) of said cover layer (12, 12′, 12″).

51. A kit (10) as claimed in claim 50, wherein the means (16) for penetrating into the soil are screwed into corresponding seats defined on the external surface (15) of said cover layer (12, 12′, 12″).

52. A kit (10) as claimed in any of the preceding claims, wherein the means (16) for penetrating into the soil comprise a plurality of protruding elements that are staggered according to a regular pattern (22).

53. A kit (10) as claimed in the preceding claim, wherein the means (16) for penetrating into the soil comprise a plurality of protruding elements that are disposed in staggered rows (22).

54. A kit (10) as claimed in any of the preceding claims, wherein at least two means (16) for penetrating into the soil are placed on the same ideal plane crossing the surface of the cover layer (12, 12′, 12″).

55. A kit (10) as claimed in any of the preceding claims, wherein the means (16) for penetrating into the soil are groups in rows (22) that are arranged so as to lie in the same cross plane of the cover layer (12, 12′, 12″) and so as to be spaced along the circumferential development (32) of the cover itself.

56. A kit (10) as claimed in any of the claims 53-55, wherein the rows (22) of the means (6) for penetrating into the soil are staggered along the longitudinal development (30) of the cover layer (12, 12′, 12″), that is along the length of the rotating axis.

57. A kit (10) as claimed in claims 53-56, wherein the staggered rows (22) of the means (6) for penetrating into the soil are arranged so as to cover the whole circumferential development (32) of the cover layer (12, 12′, 12″).

58. A kit (10) as claimed in any of the claims 53-57, wherein the means (6) for penetrating into the soil belonging to different rows (22) are partially overlapped along the longitudinal direction (30) of the cover layer (12, 12′, 12″).

59. A kit (10) as claimed in any of the preceding claims, wherein the means (6) for penetrating into the soil are arranged on the surface of the cover layer (12, 12′, 12″) so that at least two of said penetrating means (6) are faced along the longitudinal development (30) of the cover layer (12, 12′, 12″).

60. A kit (10) as claimed in any of the preceding claims, wherein the means (6) for penetrating into the soil are arranged on the external surface (15) of the cover layer (12, 12′, 12″) so as to be staggered in a circumferential direction (32) of the cover itself.

61. An improved apparatus for soil treating comprising a traditional roller (2) with one or more rollers rotating about the same axis of rotation, that is provided with a cylindrical surface (3), for soil compacting and a kit (10) as claimed in any of the preceding claims.

62. Method for converting a roller (2) into an aerator tool (11), by applying and mounting at need on said roller a kit (10) as claimed in any of the preceding claims.
